(19) United States
(12) Patent Application Publication
(10) Pub. No.: US 2015/0144544 A1
(43) Pub. Date: May 28, 2015

(54) WASTEWATER SCREEN FILTER AND CHAIN TENSIONER

(71) Applicant: Headworks Bio Inc., Houston, TX (US)

(72) Inventors: Steven Davenport, Houston, TX (US); Joel Santos-Maldonado, Houston, TX (US)

(21) Appl. No.: 14/412,589

(22) PCT Filed: Jul. 3, 2013
(86) PCT No.: PCT/US2013/049308

§ 371 Date: Jan. 2, 2015

Related U.S. Application Data
(60) Provisional application No. 61/667,631, filed on Jul. 3, 2012.

(51) Int. Cl. B01D 35/28; B01D 29/00

(52) U.S. Cl. CPC B01D 35/28; B01D 29/0093
USPC 210/231; 29/890.14

(57) ABSTRACT

A screen filter for wastewater applications includes a chain tensioner assembly configured to provide a tensioning force for a screen filter chain. The chain tensioner assembly includes a slide plate configured to move axially with respect to the screen filter chain, and a shaft mount attached to the slide plate and configured to mount a shaft. The chain tensioner assembly additionally includes an abutment member attached to the slide plate. The chain tensioner assembly further includes a spring adjuster having at least one spring and configured to contact the abutment member to provide a bias force to the slide plate.

### BACKGROUND OF THE INVENTION

The subject matter disclosed herein relates to the field of wastewater treatment, and more particularly to a screen filter for use in such applications that provides for a chain drive of a scraper assembly used to remove debris from rakes within the screen filter.

In the field of wastewater treatment, a range of components are used at various stages of water capture and processing, ultimately resulting in treated water that may be used or released into the environment. One component that is often found at the initial stages of wastewater collection and treatment is the screen filter. These devices allow for water to flow into a screen which collects larger debris while allowing the strained water to flow through for further filtering and treatment. In one type of screen filter, one or more chain-mounted rakes are continuously moved over a screen field to remove the debris that is collected from the water. Typically, the one or more chains are moved by a drive assembly over sprockets, so that the collection and raking operations may be performed without operator intervention, at least during times when water is flowing through the filter. The debris is scraped from the rakes and may be disposed of accordingly.

Persistent problems in such devices may result from wear on the moving elements, particularly on the chain and on the sprocket assemblies used to guide the chain. Such wear may result in the loss of efficiency of the drive used to move the rakes, and may be costly. There is a need, therefore, for improved techniques for managing the wear and tear of the chain drive and related components.

### BRIEF DESCRIPTION OF THE INVENTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In one embodiment, a screen filter for wastewater applications includes a chain tensioner assembly configured to provide a tensioning force for a screen filter chain. The chain tensioner assembly includes a slide plate configured to move axially with respect to the screen filter chain, and a shaft mount attached to the slide plate and configured to mount a shaft. The chain tensioner assembly additionally includes an abutment member attached to the slide plate. The chain tensioner assembly further includes a spring adjuster having at least one spring and configured to contact the abutment member to provide a bias force to the slide plate.

In a second embodiment, a screen filter for wastewater applications includes a first chain tensioner assembly. The first chain tensioner assembly is configured to provide a first tensioning force for a first screen filter chain. The first chain tensioner assembly includes a slide plate configured to move axially with respect to the first screen filter chain, and a torque arm attached to the slide plate and configured to mount a chain drive assembly. The first chain tensioner assembly additionally includes an abutment member attached to the slide plate and a spring adjuster having at least one spring and configured to contact the abutment member to provide a bias force to the slide plate.

In a third embodiment, a method for making a screen filter for wastewater applications includes a method for making a first chain tensioner. The method for making the first chain tensioner includes attaching a first 90° angle bracket to a first side wall, and attaching a second 90° angle bracket to the first side wall. The method for making the first chain tensioner additionally includes disposing a slide plate having a shaft mount between the first and the second 90° angle brackets, wherein the slide plate is configured to move axially with respect to the first side wall. The method for making the first chain tensioner further includes attaching a spring adjuster comprising at least one spring to the first side wall, wherein the spring adjuster is configured to provide a bias force to the slide plate, wherein the shaft mount is configured to mount a shaft configured to drive a screen filter chain.

The present invention provides for a novel chain tensioner disposed in a chain drive of a screen filter. The invention offers an improved tensioning control for the chain, such that a tensioning force is applied more evenly, thus minimizing or eliminating mechanical stress between components, including components disposed at opposing ends of the chain. In one embodiment, the chain tensioner may include an adjustable, floating side plate suitable for adjusting the tensioning force. Accordingly, as the chain becomes more “loose” due to wear, the tensioning force may be adjusted to compensate for any slack. The chain tensioner may also include a bias force, such as a bias force provided by one or more springs, suitable for aiding in the tensioning adjustment. By providing for an improved chain tension, the efficiency of the chain drive may be improved, and component wear may be minimized.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a perspective view of an exemplary screen filter for wastewater applications employing a chain tensioner assembly, in accordance with the invention;

FIG. 2 is an elevational view of the screen filter of FIG. 1, showing certain functional components, including the chain tensioner assembly;

FIG. 3 is a more detailed view of the chain tensioner assembly of FIG. 2, including positional adjustment components and a spring adjuster device;

FIG. 4 is a more detailed view of the chain tensioner assembly of FIG. 3, including positional adjustment components;

FIG. 5 is a perspective view of the spring adjuster device of FIG. 2;

FIG. 6 is a detailed view of a chain tensioner assembly used to provide for chain tensioning and to mount a chain drive assembly; and

FIG. 7 is a detailed perspective view of certain components of the chain tensioner assembly of FIG. 6.

### DETAILED DESCRIPTION OF THE INVENTION

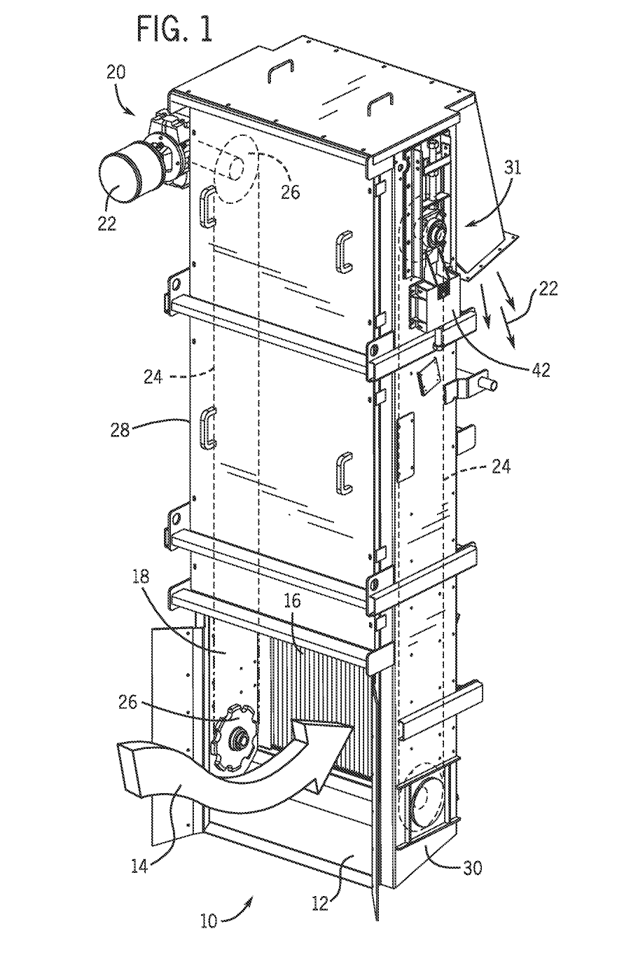

FIG. 1 is a perspective view of an exemplary screen filter 10 that would be used in a wastewater treatment facility. As will be appreciated by those skilled in the art, the screen filter may be positioned vertically or at an angle at an entrance side of a collection point or treatment facility. An open end 12 of the screen filter 10 receives a flow of water as indicated by arrow 14 through a filter screen 16 which may be seen in the interior volume 18 in the image of FIG. 1. The filter screen 16 may stop large debris from flowing through the filter 10 to downstream components, while allowing water to flow through for subsequent filtering and treatment.

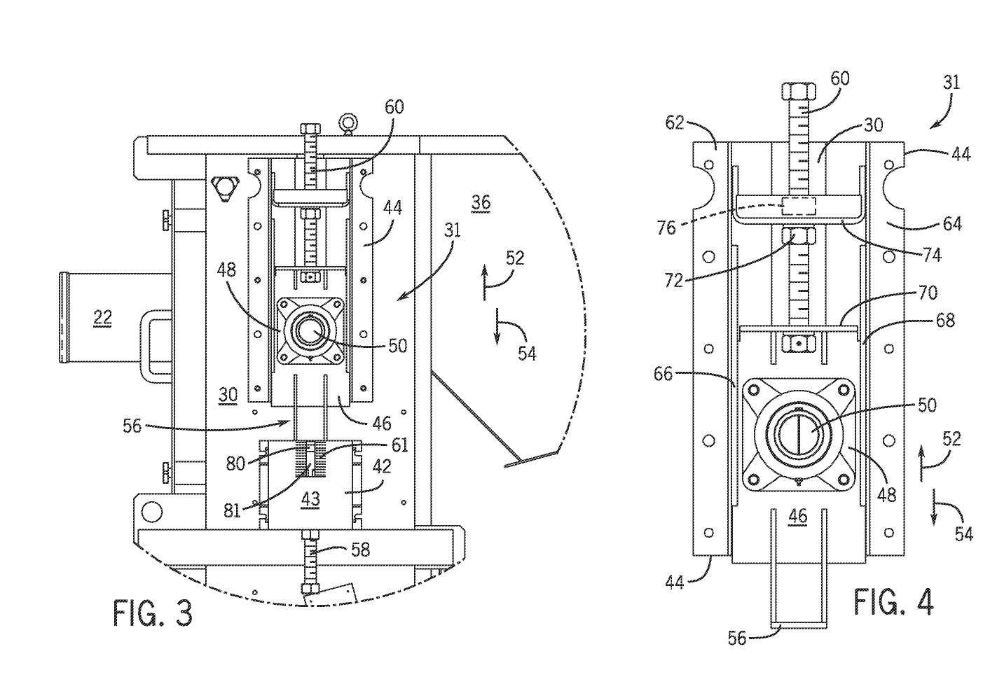

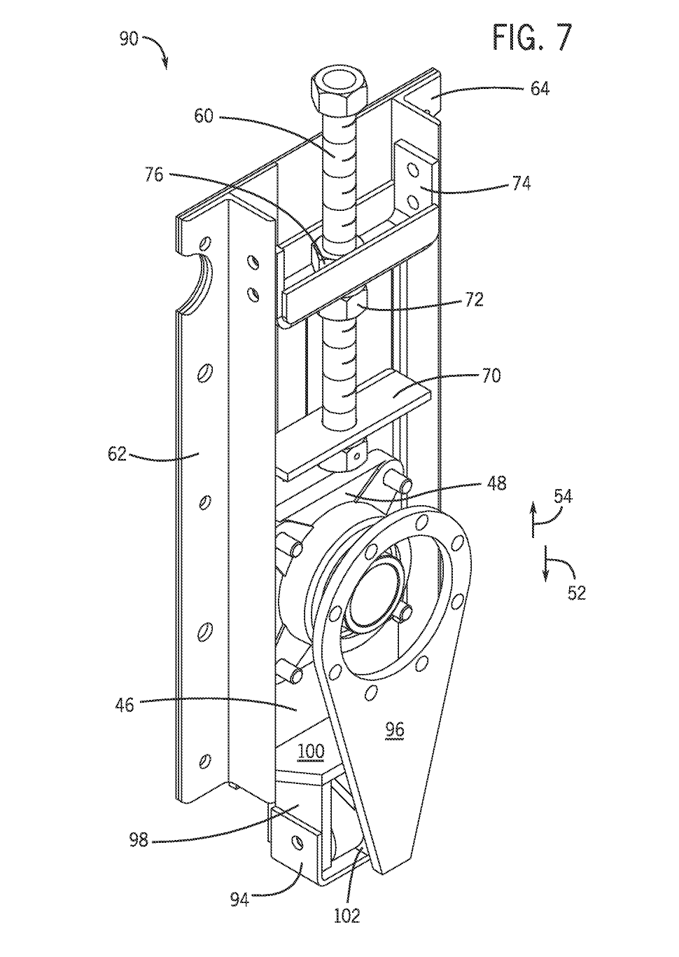

Also depicted is a chain drive assembly 20 including a motor, such as an electric motor 22 used to drive one or more chains 24 (depicted as a broken line). The chains 24 may use sprockets, such as a sprocket 26, to move a rake useful in removing debris that may collect on the filter screen 16. The debris may be collected and disposed of appropriately, as depicted by arrows 22. Unfortunately, wear on the chain 24 or improper chain 24 tensioning may result in certain “slackness,” thus reducing overall efficiency of the chain drive assembly 20 and increasing wear on components of the screen filter 10. Advantageously, the chain 24 is mounted on a drive side wall 28 having a drive side chain tensioner shown in more detail in FIGS. 6 and 7. Likewise, a chain 24 is mounted on an opposite side wall 30 having a wall side chain tensioner 31 shown in more detail in FIGS. 3 and 4. The chain tensioner assemblies, such as the chain tensioner 31 described herein, may maintain a more constant chain 24 tension, thus improving chain drive 20 efficiency and minimizing wear and tear on components of the screen filter 10.

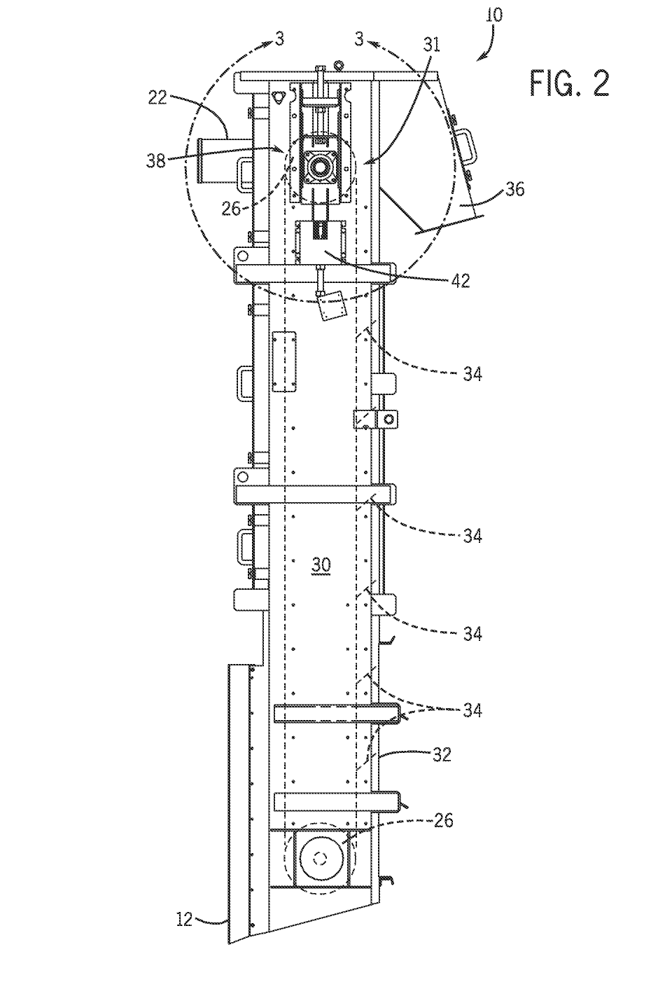

FIG. 2 is a side elevational view of the exemplary screen filter of FIG. 1. More specifically, the figure depicts the side wall 30 opposite the drive assembly 20 having the electric motor 20. A screen field 32 is disposed near a bottom downstream side of the screen filter 10 and serves to collect the debris that may be present in the wastewater that flows through the filter. Above the screen field 32, one or more plate sections may be provided for allowing the debris to be raised on the chain 24 and rakes 34 positioned along the chain. Depending upon the design of the screen filter, and its length, one or many such rakes or scrapers 24 may be provided along the length of the chain. These rakes 24 are raised on the downstream side of the interior volume of the screen filter and lowered along the upstream side. The rakes 24 progressively advance over the screen field 32 and remove any debris that has collected there, raising it to an upper end of the screen filter 10. A scraper assembly may contacts the rakes 24 at on a debris chute 36 end of the screen filter 10 and pushes the debris into the debris chute 36.

As shown in FIG. 2, the chain 24 is wound around sprockets 26 and is guided by the sprockets at lower and upper ends of the screen filter 10. In most applications, two such chains 24 will be provided, one on either side of the assembly. The chains 24, then, span these two sprockets 26 and over a length of the screen filter 10. The chains 24 are driven by a gear reducer 38 at the upper end of the screen filter, which is itself driven by the electric motor 22. This mechanism may run continuously, or at least during periods when wastewater is being received to continuously remove debris from the water and maintain the screen filter in an unobstructed operative condition. In the depicted embodiment, the chain tensioner 31 includes a spring adjuster device 42 and may be used to maintain a more suitable chain 24 tension. Indeed, should the chain 24 experience slack, the chain tensioner 31 and spring adjuster 42 may be adjusted to “take up” the slack and provide for uniform chain tension. A similar chain tensioner may be disposed on the opposite chain drive side wall 28. Accordingly, the chain tensioners may improve efficiency of the chain drive 20 and reduce wear of components of the screen filter 10.

FIG. 3 illustrates certain of the components of the chain tensioner 31, including the spring adjuster 42 shown with a cover 43. To install the chain tensioner 31, a guide assembly 44 may be bolted, welded, or otherwise secured to the side wall 30. The guide assembly 44 may be used to guide a slide plate 46 onto which a shaft mount plate 48 may be secured. The shaft mount plate 48 may be used to mount a shaft 50 suitable for rotatably coupling the sprocket 26 to the shaft mount plate 48 (and slide plate 46). The depicted arrangement enables the slide plate 46 to axially move (e.g., “slide”) in directions 52 and 54, axially along the side wall 30 and chain 24. Indeed, in certain embodiments, the slide plate 46 may move at least between 1% and 10%, 0.5% and 20% of the length of the screen filter 10 and/or the side wall 30.

The slide plate 46 may include an abutment member 56 suitable for coupling the slide plate 46 to the spring adjuster 42. More specifically, the spring adjuster 42 may abut a lower end of the abutment member 56 and provide a bias force in the direction 52. In one embodiment, the spring adjuster 42 may be retrofitted to an existing slide plate 46. For example, the abutment member 56 may be welded onto the slide plate 46. The spring adjuster 42 may then be attached to the side wall 30 and to a support member 57 of the screen filter 10, and positioned to contact the abutment member 56.

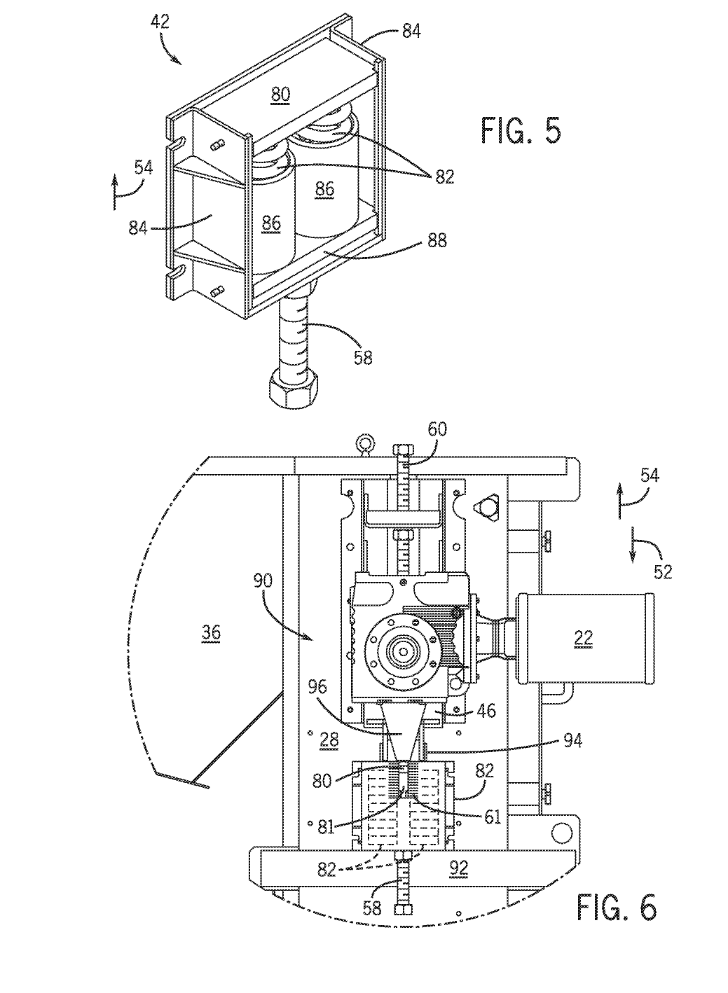

A bolt 58 may be used to increase or decrease the bias force, for example, by compressing (or decompressing) one or more springs disposed inside the spring adjuster 42, as described in more detail below with respect to FIG. 5. Likewise, a bolt 60 is provided, suitable for adjusting the slide plate 46 by moving the slide plate in the directions 52 and/or 54, as desired. By using the bolts 58 and 60, the chain tensioner 31 may be more easily adjusted to provide for an improved tension of the chain 24. The spring adjuster cover 43 may include markings 61 useful in visualizing an amount of tensioning force or “take up” that the spring adjuster 42 may be providing. The markings 61 may be compared against a member 80 visible through a slot 81 of the cover 43, to visualize the amount of tensioning force of “take up.” In use, a spring filter 10 operator may correlate the markings 61 with the member 80, and reposition the slide plate 46, as desired. Likewise, the bolt 58 may be used to adjust the spring bias. Accordingly, the chain 24 may maintained at proper tension, minimizing or eliminating slack, and thus improving the efficiency of the chain drive 20 while minimizing wear of components of the screen filter 10.

Turning to FIG. 4, the figure is a side elevation view of the upper end of the chain tensioner 31. The guide assembly 44 is depicted as including two L-brackets 62 and 64 (e.g., 90° angle brackets). The L-brackets 62 and 64 aid in guiding the slide plate 46 in moving in the directions 52 and/or 54, and also prevent the slide plate from moving in a sideways manner. Accordingly, guide rails 66 and 68 may be disposed on the L-brackets 62 and 64, respectively. The slide plate 46 is then disposed in-between the guide rails 66, 68, and the side wall 30, such that the guide rails 66, 68 are above the slide plate 46 and the side wall 30 is below the guide plate 46. The slide plate 46 may include a bolt attachment member 70, used in attaching the threaded bolt 60 to the slide plate 46. Accordingly, the bolt 60 may act as a positioning member used to position the slide plate 46 axially with respect to the guide assembly 44 and the side wall 30.

In one embodiment, to move the slide plate 46, a fastening nut 72 may be loosened, and the bolt 60 may be rotated to move the slide plate 46 to a desired position. Once the slide plate 46 is placed in the desired position, the fastening nut 72 may then tightened and abutted to a static member, such as a U-flange 74. The U-flange 74 may be securely attached to the L-brackets 62 and 64. A second fastening nut 76 may also be used to secure and tighten the bolt to the U-flange 74. Accordingly, the nuts 74 and 76 may secure the bolt 60 and attached slide plate 46 to a desired position respective to the side wall 30. As mentioned previously, the slide plate 46 may be attached to the shaft mount plate 48 having the shaft 50. By more suitable positioning the shaft 50 with respect to the side wall 30, the chain 24 may experience an improved tensioning force. Additionally, a bias force may be applied to the slide plate 46, for example by using the attached abutment member 56, as described in more detail below with respect to FIG. 5.

FIG. 5 is a perspective view of the spring adjuster 42 with the cover 43 removed. As mentioned above, the spring adjuster 42 may provide a bias force in the direction 54, useful in adjusting the slide plate 46 and/or providing for added tensioning force. To provide for the bias force, a top member 80 may be disposed to contact the abutment member 56 (shown in FIG. 4) of the slide plate 46. The top member 80 may also be disposed on top of one or more springs 82. The springs 82 may be coiled metal springs, an elastomeric component (e.g., elastomeric tube), an adjustable piston (e.g., liquid or gas filled piston), a hydraulic ram, or a combination thereof. In one embodiment, the hydraulic ram may use liquid entering through the screen filter 10 as a source of power. When compressed, the springs 82 provide for the bias force in the direction 54, thus aiding in tensioning the chain 24.

A pair of L-brackets 84 (e.g., 90° angle brackets) are shown as aiding in guiding the movements of the top member 80, as well as providing for side walls suitable in enclosing the sides spring adjuster 42. The springs 82 and spring enclosures 86 may rest on a bottom member 88. The bottom member 88 may also be a moveable member. In the depicted example, the bolt 58 may be used to move the bottom member 88, thus compressing or releasing spring 82 tension. Accordingly, the bias tension for the chain tensioner 31 may be easily adjusted by rotating the bolt 58. The spring adjuster 82 may be additionally provided with springs 82 having different spring forces. Consequently, during installation of the spring adjuster 82, the desired spring 82 may be selected and installed, and the bolt 60 adjusted to provide for a desired spring 82 compression. By more suitably tensioning the chain 24, the spring adjuster 42 may enable an improved and more efficient chain drive 20.

Turning to FIG. 6, the figure is a side elevation view of a chain tensioner 90 suitable for use with the chain drive assembly 20. In the depicted embodiment, the spring adjuster 42 is attached onto the side wall and disposed on top of a side stiffener member 92. The spring adjuster 42 is further positioned to contact an abutment member 94. The abutment member 94 may be attached to the slide plate 46, as described in more detail below with respect to FIG. 7, and used to couple the slide plate 46 to the chain tensioner 90. As mentioned above, the spring adjuster 42 may be retrofitted into screen filters 10 having the slide plate 46. As illustrated, the chain tensioner 90 may also include a torque arm 96 suitable for mounting the chain drive assembly 20 to the slide plate 46.

Bolts 58 and 60 may be used to adjust the slide plate 46 and the spring adjuster 82, respectively. For example, bolt 60 may be used to axially move the slide plate 46, torque arm 96, and attached chain drive assembly 20 in directions 52 and/or 54. Likewise, the bolt 58 may be used to compress or decompress the springs 82, which in turn may be used to provide a bias force suitable for moving the slide plate 46, the torque arm 96, and the chain drive assembly 20 in the direction 54. By providing for a re-positionable chain drive assembly 20 and chain tensioner 90, the techniques described herein may enable a better alignment of the chains 24 and improved efficiency of the chain drive assembly 20.

FIG. 7 is a perspective view of the chain tensioner 90 connected to the torque arm 96. In the depicted embodiment, an arm attachment assembly 98 is secured to the slide plate 46 by using an attachment flange 100. Additionally, the torque arm 96 is attached to the attachment assembly 98 by using an arm flange 102. In the presently contemplated embodiment, the flanges 100 and 102 are welded to the slide plate 46 and to the torque arm 96, respectively. Also shown is the abutment member 94 that may be used to contact, for example, the top member 80 of the spring adjuster 42 (shown in FIG. 5). Accordingly, a bias force may be applied to the abutment member 94 by the spring adjuster 42, suitable for moving the slide plate 46 and torque arm 96 in the direction 54.

Also depicted are the shaft mount plate 48 suitable for attaching a shaft to the chain drive assembly 20, and the bolt attachment member 70 used to attach the bolt 60 to the slide plate 46. As mentioned above, the bolt 60 may be used to axially move the slide plate 46 along the L-brackets 62 and 64 in the directions 52 and/or 54. Once the slide plate 46 is positioned into a desired location along the L-brackets 62 64, the nuts 72 and 76 may be tightened against U-flange 74 to secure the slide plate 46 in place. The springs 82 of the spring adjuster 42 may then be adjusted to provide for the bias force useful in aiding chain 24 chain tensioning. By using the chain tensioner assemblies 31 and 90, the shaft 50 may be more easily disposed between the side walls 28, 30 and aligned. Additionally, the chain tensioner assemblies 31 and 90 may enable an improved chain 24 tension, thus improving the efficiency of the chain drive 20 and minimizing wear for the screen filter 10 and related components.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A screen filter for wastewater applications, comprising:
a chain tensioner assembly configured to provide a tensioning force for a screen filter chain, the chain tensioner comprising:
a slide plate configured to move axially with respect to the screen filter chain;
a shaft mount attached to the slide plate and configured to mount a shaft;
an abutment member attached to the slide plate; and
a spring adjuster having at least one spring and configured to contact the abutment member to provide a bias force to the slide plate.

2. The screen filter of claim 1, wherein the spring adjuster comprises a bolt coupled to the at least one spring and configured to adjust the bias force.

3. The screen filter of claim 1, wherein the at least one spring comprises a helical spring, an elastomeric component, an adjustable piston, a hydraulic ram, or a combination thereof.

4. The screen filter of claim 1, comprising a bolt attached to the slide plate and configured to move the slide plate axially with respect to the screen filter chain.

5. The screen filter of claim 4, comprising at least one nut configured to thread onto the bolt to substantially secure the side plate to a static member.

6. The screen filter of claim 1, wherein the spring adjuster comprises a plurality of markings configured to provide a visualization of an amount of the bias force.

7. The screen filter of claim 1, comprising a first L-bracket and a second L-bracket attached to a side wall, wherein first and the second L-brackets are configured to guide an axial movement of the slide plate and to prevent a radial movement of the slide plate.

8. The screen filter of claim 1, wherein the slide plate is configured to move axially between 0.5% and 20% of a length of a screen filter side wall.

9. The screen filter of claim 1, comprising a torque arm attached to the slide plate and configured to mount a chain drive assembly.

10. The screen filter of claim 1, wherein the spring adjuster is configured to be retrofitted into the chain tensioner.

11. A screen filter for wastewater applications, comprising:
a first chain tensioner assembly configured to provide a first tensioning force for a first screen filter chain comprising:
a slide plate configured to move axially with respect to the first screen filter chain;
a torque arm attached to the slide plate and configured to mount a chain drive assembly;
an abutment member attached to the slide plate; and
a spring adjuster having at least one spring and configured to contact the abutment member to provide a bias force to the slide plate.

12. The screen filter of claim 11, comprising a second chain tensioner assembly configured to provide a second tensioning force for a second screen filter chain, wherein the first chain tensioner assembly is disposed on a first side wall, and the second chain tensioner assembly is disposed on a second side wall opposite the first side wall.

13. The screen filter of claim 11, comprising the chain drive assembly configured to rotatably drive the screen filter chain.

14. The screen filter of claim 13, comprising a shaft mount attached to the slide plate and configured to mount a shaft, wherein a first end of the shaft is configured to attach to the chain drive assembly and the second end of the shaft is configured to attach to a sprocket, and the sprocket is configured to engage the first screen filter chain.

15. A method for making a screen filter for wastewater applications, comprising:
making a first chain tensioner, wherein the making the first chain tensioner comprises:
attaching a first 90° angle bracket to a first side wall;
attaching a second 90° angle bracket to the first side wall;
disposing a slide plate having a shaft mount between the first and the second 90° angle brackets, wherein the slide plate is configured to move axially with respect to the first side wall;
attaching a spring adjuster comprising at least one spring onto the first side wall, wherein the spring adjuster is configured to provide a bias force to the slide plate, and wherein the shaft mount is configured to mount a shaft, and wherein the shaft is configured to drive a chain.

16. The method of claim 15, wherein the at least one spring comprises a helical spring, an elastomeric component, a piston, a hydraulic ram, or a combination thereof.

17. The method of claim 16, wherein disposing the slide plate between the first and the second 90° angle brackets comprises attaching a first guide rail to the first 90° angle bracket, attaching a second guide rail to the second 90° angle bracket, and disposing the slide plate below the first and the second guide rails and above the first side wall.

18. The method of claim 15, comprising attaching a bolt to the slide plate, wherein the bolt is configured to allow positional adjustment of the slide plate.

19. The method of claim 18, comprising attaching a nut to the bolt, wherein the nut is configured to secure the bolt to a static member.

20. The method of claim 15, comprising making a second chain tensioner and disposing the second chain tensioner on a second side wall opposite the first side wall, and disposing the shaft between the first and the second chain tensioners.
